(19) United States
(12) Patent Application Publication
(10) Pub. No.: US 2026/0143067 A1
(43) Pub. Date: May 21, 2026

(54) DIAGNOSTIC SYSTEM AND METHOD

(71) Applicant: CANON KABUSHIKI KAISHA, Tokyo (JP)

(72) Inventor: YASUAKI KAWASHIMA, Kanagawa (JP)

(21) Appl. No.: 19/450,216

(22) Filed: Jan. 15, 2026

Related U.S. Application Data
(63) Continuation of application No. PCT/JP2024/025197, filed on Jul. 12, 2024.

(30) Foreign Application Priority Data
Jul. 21, 2023 (JP) 2023-118861

(51) Int. Cl. H04N 1/00

(52) U.S. Cl. CPC H04N 1/00029; H04N 1/00076; H04N 1/00474; H04N 2201/0094

(57) ABSTRACT

A diagnostic system includes a diagnostic unit for executing a diagnostic process for determining, by using operation information about an image processing apparatus and a setting value of the image processing apparatus, a cause of a trouble that has occurred in the image processing apparatus and a solution to the trouble, a provision unit for providing a screen that displays a diagnostic result of the diagnostic process and information necessary for re-diagnosis obtained from the image processing apparatus, and a reception unit for receiving at least one of an instruction for acquiring the information necessary for re-diagnosis from the image processing apparatus and an instruction for entering the information necessary for re-diagnosis by an operator via the screen. The diagnostic unit executes the diagnostic process again, based on the information necessary for re-diagnosis.

### CROSS-REFERENCE TO RELATED APPLICATIONS

This application is a Continuation of International Patent Application No. PCT/JP2024/025197, filed July 12, 2024, which claims the benefit of Japanese Patent Application No. 2023-118861, filed July 21, 2023, both of which are hereby incorporated by reference herein in their entirety.

### BACKGROUND

### Field of the Technology

The present disclosure relates to a diagnostic technique that is executed after operation information about an image processing apparatus is collected.

### Description of the Related Art

There is a remote diagnostic technique used when a trouble occurs in an image processing apparatus. In this technique, the trouble is diagnosed remotely, based on information sent from the image processing apparatus to a diagnostic system located at a service center, and an operator at the service center or a user of the image processing apparatus is provided with information about a solution to the trouble.

Japanese Patent Laid-Open No. 2020-174291 describes a technique in which a user is allowed to make an inquiry about a solution by selecting information that matches the trouble to be solved from a plurality of choices, generating an identification (ID) that uniquely determines the trouble based on the result selected by the user, and sending the ID to a diagnostic system.

However, there are issues that cannot be solved by the conventional technique.

Recent image processing apparatuses also have many functions of communicating with external apparatuses. When a trouble occurs in such a function, various setting values of the image processing apparatus or information about an external apparatus may also be needed. In such a case, a definitive diagnosis cannot be made solely with the ID generated based on the selection by the user in accordance with the conventional technique.

In addition, to deal with a trouble, it may be effective to execute re-diagnosis using necessary additional information which has been acquired from a target apparatus, or which has been acquired by asking the apparatus user. That is, additional information is needed for executing suitable re-diagnosis. However, because an operator communicating with the customer to deal with the trouble cannot determine all the contents of the diagnostic process executed in the system, it is very difficult for the operator to take an action such as efficiently acquiring the additional information and the like.

### SUMMARY

According to an aspect of the present disclosure, a diagnostic system includes a diagnostic unit for executing a diagnostic process for determining, by using operation information about an image processing apparatus and a setting value of the image processing apparatus, a cause of a trouble that has occurred in the image processing apparatus and a solution to the trouble, a provision unit for providing a screen that displays a diagnostic result of the diagnostic process and information necessary for re-diagnosis obtained from the image processing apparatus, and a reception unit for receiving at least one of an instruction for acquiring the information necessary for re-diagnosis from the image processing apparatus and an instruction for entering the information necessary for re-diagnosis by an operator via the screen. The diagnostic unit executes the diagnostic process again, based on the information necessary for re-diagnosis.

Features of the present disclosure will become apparent from the following description of embodiments with reference to the attached drawings.

### BRIEF DESCRIPTION OF THE DRAWINGS

FIG. 1 illustrates an example of a system configuration according to the present embodiment.

FIG. 2 illustrates an example of a hardware configuration of a multifunction peripheral (MFP).

FIG. 3 illustrates an example of a hardware configuration of a diagnostic server.

FIG. 4 is a sequence diagram illustrating an example of an entire process flow according to the present embodiment.

FIG. 5 is a flowchart illustrating an example of a process of the MFP.

FIG. 6 illustrates an example of a main menu screen of the MFP.

FIG. 7 illustrates an example of a SEND function screen of the MFP.

FIG. 8A is a flowchart illustrating an example of a process of the diagnostic server.

FIGS. 8B is a flowchart illustrating the example of the process of the diagnostic server.

FIG. 9 illustrates an example of a basic information input screen of the diagnostic server.

FIG. 10 illustrates an example of a diagnostic result screen provided by the diagnostic server.

FIG. 11 illustrates another example of the diagnostic result screen provided by the diagnostic server.

FIG. 12 is a flowchart illustrating an example of a diagnostic process.

FIG. 13A is a flowchart illustrating an example of a diagnostic flow on an electronic mail sending function.

FIG. 13B is a flowchart illustrating the example of the diagnostic flow on an electronic mail sending function.

FIG. 14 is a flowchart illustrating an example of a solution process included in the diagnostic process.

FIG. 15 illustrates an example of a delivery reservation screen.

### DESCRIPTION OF THE EMBODIMENTS

In the present embodiment, an example of a diagnostic system will be described. In this diagnostic system, an image processing apparatus and a diagnostic application of a diagnostic server coordinate with each other, so as to diagnose a trouble that has occurred in the image processing apparatus. Although the present embodiment will be described using a multifunction peripheral (MFP) as an example of the image processing apparatus, the image processing apparatus may also be another apparatus, such as a single function printer or a scanner having a network function.

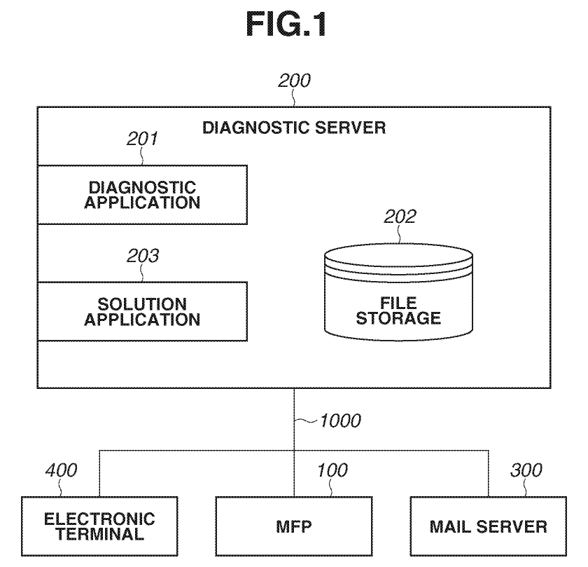

FIG. 1 illustrates an example of a system configuration according to the present embodiment. The system according to the present embodiment includes an MFP 100, a diagnostic server 200, a mail server 300, and an electronic terminal 400.

In FIG. 1, the diagnostic server 200 is connected to each of the MFP 100, the mail server 300, and the electronic terminal 400 via a network 1000. The MFP 100 and the diagnostic server 200 are also communicably connected to each other via a network 1000. The network 1000 may be any network that can execute data transmission and reception.

The MFP 100 is, for example, a multifunction printer or a desktop scanner, and has a print function and a scan function. The MFP 100 sends a setting value, which is used when the MFP 100 executes a function thereof, and a result obtained by the execution of the function to a diagnostic application 201, which will be described below, at a specified timing.

The diagnostic server 200 includes the diagnostic application 201, a file storage 202, and a solution application 203. The diagnostic application 201 stores a setting value received from the MFP 100 and a execution result of a function in the file storage 202, and executes a diagnosis on the setting value and the execution result of the function stored in the file storage 202. In addition, when the diagnostic application 201 determines a diagnosis, the diagnostic application 201 stores information about a solution necessary for the MFP 100 in the file storage 202. A schedule about the solution to be executed is also stored as needed. The solution application 203 provides the MFP 100 with the solution, based on the information stored in the file storage 202 by the diagnostic application 201. Although the present embodiment assumes that the above-described information is stored in the file storage 202, the information may also be stored in a relational database, a key-value database, or the like.

The mail server 300 is a typical mail server, which is a transmission destination of mails of the MFP 100.

Examples of the electronic terminal 400 include a personal computer (PC), a smartphone, and a tablet terminal. The electronic terminal 400 can be operated by a user, and can co-operate with functions of the MFP 100. Examples of the functions of the MFP 100, which are usable by the electronic terminal 400, include, for example, a file sharing function using Server Message Block protocol (hereinafter, “SMB protocol”), and a print function using a printer driver, but other functions are also applicable. Because these functions are known techniques, detailed description thereof will be omitted.

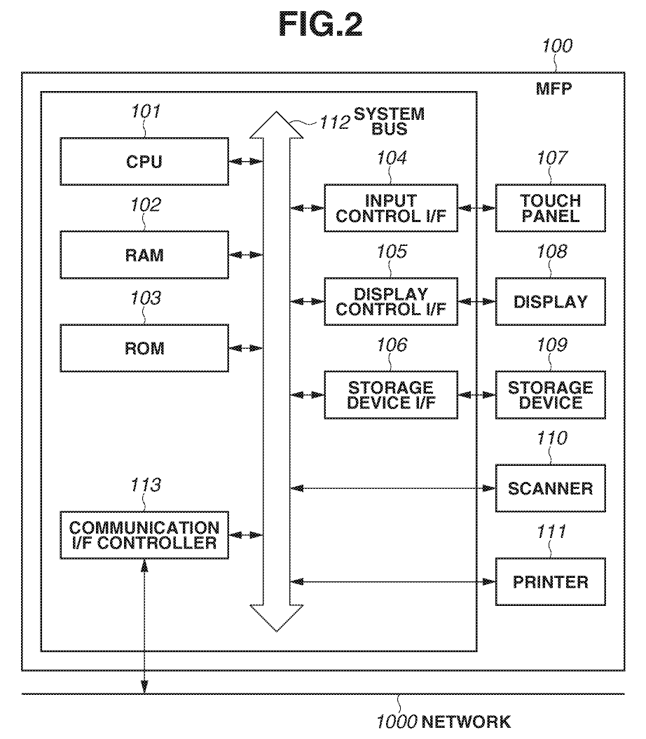

FIG. 2 illustrates an example of a hardware configuration of the MFP 100 according to the present embodiment. FIG. 2 illustrates an example for the description of the present embodiment, and therefore, it is needless to say that the configuration may include other units, or may be another configuration as long as the same effects as those according to the present embodiment are achieved. A central processing unit (CPU) 101, a random-access memory (RAM) 102, a read-only memory (ROM) 103, an input control interface (I/F) 104, a display control I/F 105, a storage device I/F 106, and a communication I/F controller 113 are connected to a system bus 112. In addition, a scanner 110 and a printer 111 are also connected to the system bus 112. The units connected to the system bus 112 are configured to be capable of exchanging data with each other via the system bus 112.

The CPU 101 is a unit that controls various units, and executes data calculation and processing. The RAM 102 is a volatile memory, and is used as a temporary storage area such as a main memory or a work area of the CPU 101. The ROM 103 is a non-volatile memory, and stores image data, other data, various kinds of programs for operations of the CPU 101, and the like in their respective predetermined areas. The CPU 101 controls various units of the MFP 100 in accordance with programs stored, for example, in the ROM 103 by using the RAM 102 as a work memory. These programs for operations of the CPU 101 may be stored in a storage device 109 as well as the ROM 103.

The communication I/F controller 113 executes communication through various kinds of networks such as a local area network (LAN), the Internet, a wired network, and a wireless network, under control of the CPU 101. Various apparatuses such as PCs, other MFPs, printers, and servers are connected to the network 1000 such that these apparatuses can communicate with the MFP 100. In addition, the diagnostic server 200 and the mail server 300, which will be described below, are also connected via the communication I/F controller 113.

The input control I/F 104 receives a user operation, generates a control signal based on the operation, and supplies the control signal to the CPU 101. For example, the input control I/F 104 is connected to input devices that receive user operations. These input devices are, for example, a text information input device such as a keyboard (not illustrated), hard keys for directly inputting numerical values, etc., and a pointing device such as a touch panel 107. The touch panel 107 is an input device that outputs coordinate information based on a position touched on, for example, a flat input unit thereof. Hereinafter, although the present embodiment assumes that the user operates a touch panel, it is needless to say that the user may use another device. The CPU 101 controls various units of the MFP 100 in accordance with a program, based on a control signal that the input control I/F 104 has generated and supplied in response to a user operation operated on an input device. This enables the MFP 100 to perform an operation according to the user operation.

The display control I/F 105 outputs a display signal for displaying an image to a display 108. For example, the CPU 101 generates and supplies a display control signal to the display control I/F 105 in accordance with a program. The display control I/F 105 generates a display signal based on this display control signal, and outputs the display signal to the display 108. For example, the display control I/F 105 causes the display 108 to display a graphical user interface (GUI) screen constituting a GUI, based on the display control signal generated by the CPU 101. The touch panel 107 may be integrally configured with the display 108. For example, the touch panel 107 is configured such that the light transmittance does not hinder the display of the display 108, and is attached to an upper layer of the display surface of the display 108. In addition, the input coordinates on the touch panel 107 and the display coordinates on the display 108 are associated with each other. This makes it possible to configure a GUI that provides the user with a sense of directly operating the screen on the display 108. The following description assumes that the touch panel 107 and the display 108 are configured integrally. The storage device I/F 106 is connected to the storage device 109 such as a hard disk drive (HDD) or a flash memory, for example. Under control of the CPU 101, the storage device I/F 106 reads out data from the storage device 109, and writes data to the storage device 109. The storage device 109 may be used, instead of the RAM 102 or the ROM 103.

Under control of the CPU 101, the scanner 110 reads a document and generates image data. For example, the CPU 101 causes the scanner 110 to execute a scan process in response to a user instruction that is input via the input control I/F 104. The scanner 110 reads a document placed on a document table or an auto document feeder (ADF), and generates image data by converting the document into digital data. Next, the scanner 110 stores the generated image data in the storage device 109 via the storage device I/F 106.

Under control of the CPU 101, the printer 111 prints image data stored in the storage device 109. For example, the CPU 101 causes the printer 111 to execute a print process in response to a user instruction that is input via the input control I/F 104 or in response to a command that is input from an external apparatus via the communication I/F controller 113. The printer 111 reads out image data from the storage device 109, converts the image data into data in a printable data format, and prints the data on paper.

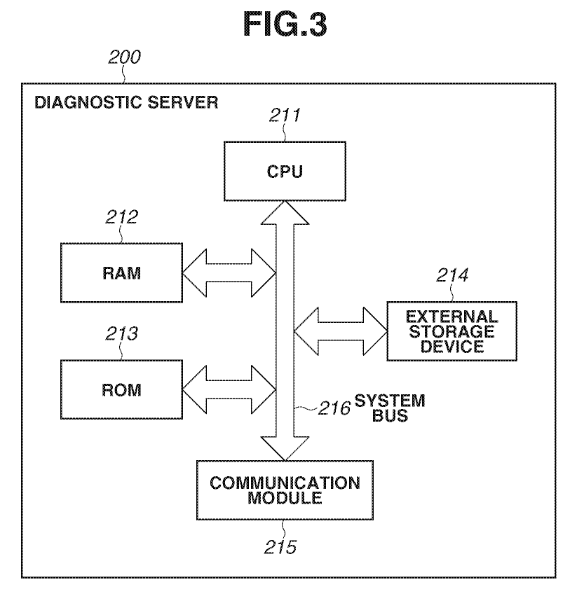

FIG. 3 illustrates an example of a hardware configuration of the diagnostic server 200. FIG. 3 illustrates merely an example for the description of the present embodiment, and therefore it is needless to say that the configuration may include other units, or may be another configuration that achieves similar effects as those according to the present embodiment.

In the diagnostic server 200, a CPU 211, a RAM 212, a ROM 213, an external storage device 214, and a communication module 215 are connected to a system bus 216. These units connected to the system bus 216 are configured to exchange data with each other via the system bus 216.

The CPU 211 is a unit that controls various units, and executes data calculation and processing. The RAM 212 is a volatile memory, and is used as a temporary storage area such as a main memory or a work area for the CPU 211. The ROM 213 is a non-volatile memory, and stores programs such as the diagnostic application 201, the solution application 203, and the like that are operated by the CPU 211, in their respective predetermined areas. The external storage device 214 is configured as the file storage 202, and stores data received from the MFP 100. The CPU 211 performs control of the RAM 212 as a work memory in accordance with the programs such as the diagnostic application 201 and the solution application 203 stored in, for example, the ROM 213. The programs for operations of the CPU 211 are not limited to being stored in the ROM 213 and may be stored in the external storage device 214.

In the present embodiment, the screen on which the diagnostic application 201 is displayed and operated is provided as a web user interface with respect to a web browser or the like via a network. The diagnostic server 200 may also be provided with a touch panel and a display, and the diagnostic application 201 may also be displayed on the touch panel and the display.

### Example of Entire Sequence in the Present Embodiment

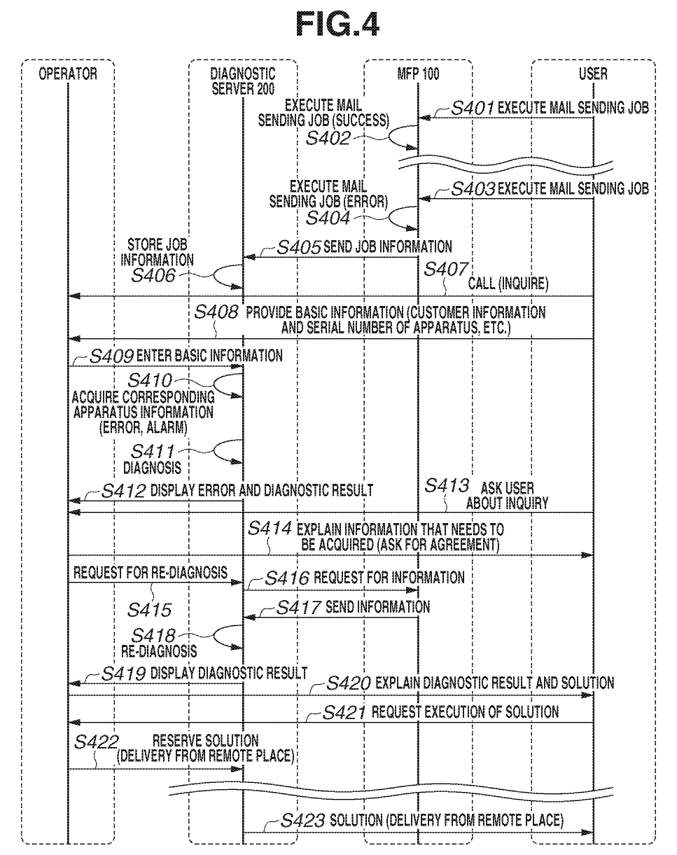

FIG. 4 is a sequence diagram illustrating an example of an enquiring process from a user according to the present embodiment.

In step S401, a user can use an MFP function such as a mail sending function of transmitting a scanned document to a certain mail destination, by operating the MFP 100. In step S402, the MFP 100 executes the corresponding function in response to the user operation in step S401. For example, in the case of the mail sending function, the MFP 100 converts the document read by the scanner 110 into a specified electronic file, and uses the communication I/F controller 113 to send the file to the mail server 300 via the network 1000. Because these functions are known functions, detailed description thereof will be omitted.

Next, in step S403, the user operates the MFP function again.

When an error occurs during the execution of the function of the MFP 100 in step S404, the MFP 100 sends, in step S405, information about the job in which the error has occurred to the diagnostic server 200. In step S406, the diagnostic server 200 stores the received information in the file storage 202, as information about the MFP 100.

In step S407, the user calls a service center to inquire about the error. In step S408, the user provides an operator at the service center with customer information and a serial number uniquely determining the apparatus in which the error has occurred.

In step S409, the operator at the service center enters the serial number of the apparatus provided by the user to the serial number input screen provided by the diagnostic application 201, by using a web browser (not illustrated).

In step S410, the diagnostic application 201 acquires the information about the error that has occurred in the MFP 100 corresponding to the serial number entered in step S409, the information being stored in the file storage 202. Next, in step S411, the diagnostic application 201 executes a diagnostic process, which will be described below, based on the acquired information.

In step S412, the diagnostic application 201 provides the web browser of the operator at the service center with a diagnostic result screen including the error that has occurred and the result of the diagnostic process.

In step S413, the operator checks the diagnostic result screen, and asks the user more questions on the phone. At this point, the error about which the user has made an inquiry is sometimes definitively determined through this communication. In step S414, the operator explains the determined result of the diagnosis of the error, about which the user has made an inquiry, and also explains information necessary for further narrowing the causes and solutions to the user who has made the inquiry. In addition, the operator obtains an agreement to acquire information necessary for re-diagnosis.

After acquiring the agreement, in step S415, the operator operates the diagnostic server 200. In this operation, the diagnostic server 200 receives a request for re-diagnosis of the error.

In step S416, the diagnostic server 200 requests the MFP 100 for information that needs to be additionally acquired. In step S417, the MFP 100 sends the operation information and apparatus information specified in this request to the diagnostic server 200.

In step S418, the diagnostic server 200 executes a diagnostic process again by using the information acquired from the MFP 100 in step S417 and the data that has already been acquired. In step S419, the diagnostic server 200 provides the web browser of the operator with the diagnostic result screen including the error that has occurred and the result of the re-diagnosis.

In step S420, based on the diagnostic result, the operator explains the diagnostic result and the solution to the user on the phone. After the explanation, in step S421, the user requests the operator to execute the solution if necessary. In step S422, the operator having been requested to execute the solution makes a reservation with the diagnostic server 200 for the execution of the solution on the error.

If the solution such as change of a setting can be executed from a remote place at a reserved time, the diagnostic server 200 delivers a setting value change command to the MFP 100 in step S423. The MFP 100 changes the setting in accordance with the command to correct the error.

### Process of MFP 100

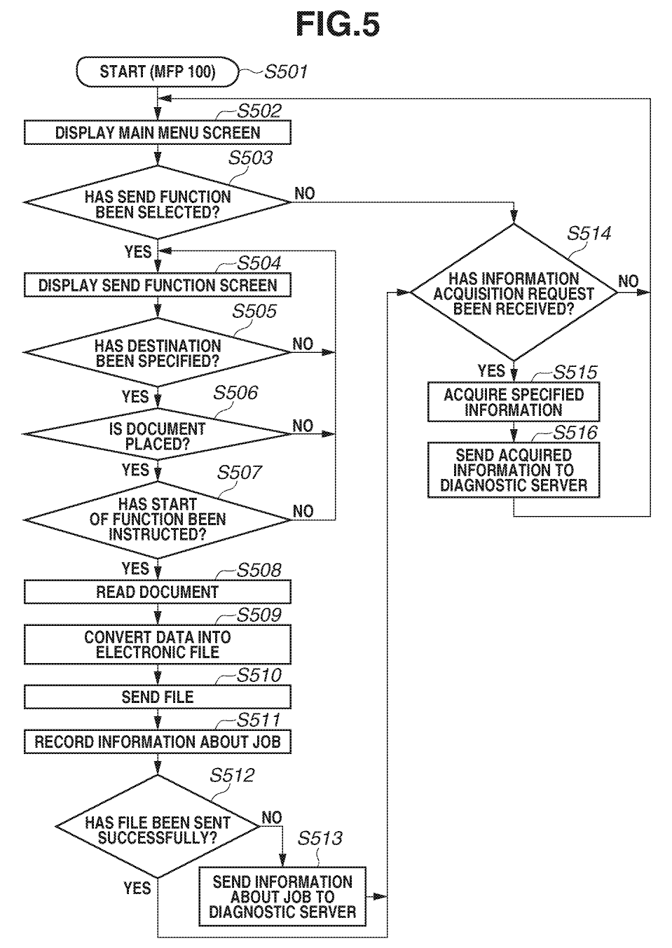

Next, the process of the MFP 100 in the above-described process sequence will be described in detail with reference to a flowchart illustrated as an example in FIG. 5.

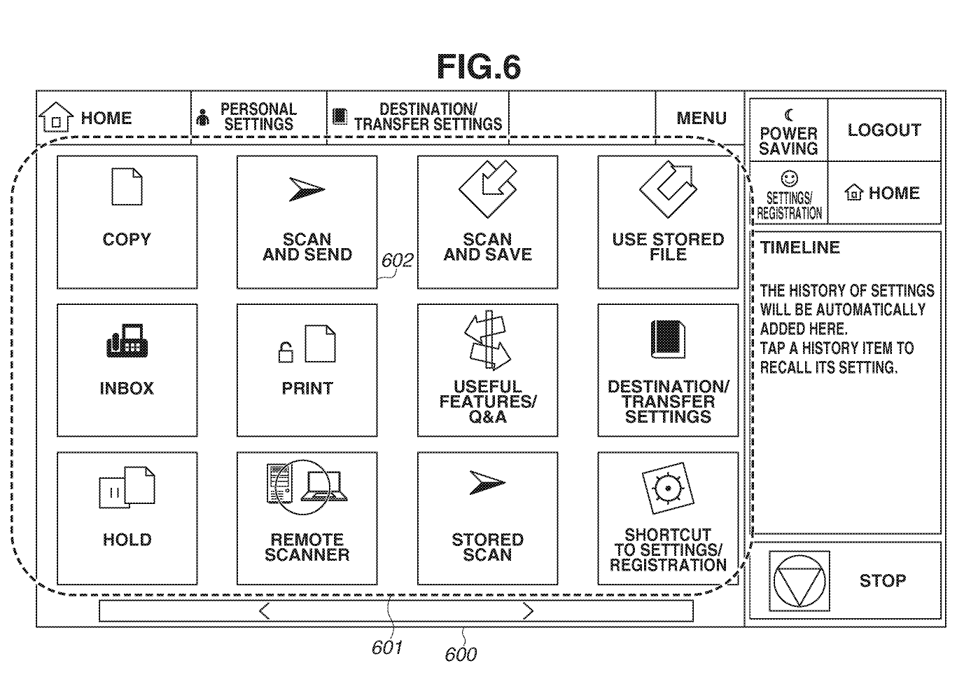

In step S501, the process is started. In step S502, a main menu screen 600 illustrated as an example in FIG. 6 is displayed. The main menu screen 600 includes an icon display area 601 indicating functions executable by the MFP 100. That is, various functions executable by the MFP 100 are listed. The present embodiment will be described by using an example in which the MFP 100 executes a “scan and send” function 602 (hereinafter, “SEND function”). Next, in step S503, that is, after displaying the main menu screen 600, the MFP 100 determines whether the SEND function has been selected.

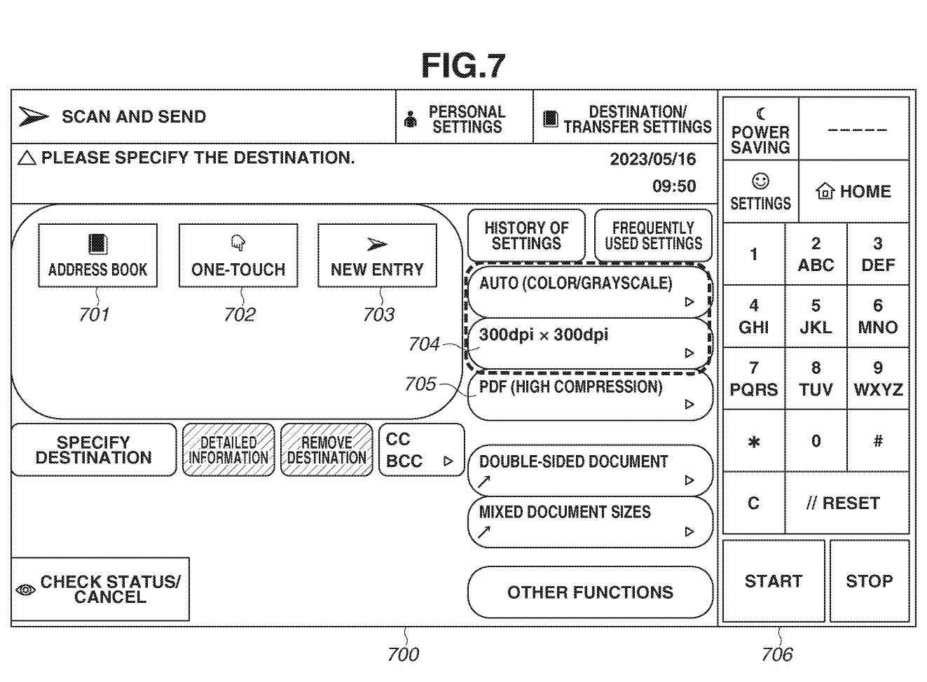

If selected (YES in step S503), the processing proceeds to step S504. In step S504, a SEND function screen 700 illustrated as an example in FIG. 7 is displayed. The SEND function screen 700 includes an address book button 701 for specifying the sending destination, a one-touch button 702, a new entry button 703, a group of scan process setting buttons 704 for scan settings, a file format button 705 for specifying the electronic file format used in sending, and a start button 706 for specifying the start of scanning and sending. Since specifying the sending destination is a known technique, description thereof will be omitted.

After the MFP 100 displays the SEND function screen 700, in step S505, the MFP 100 determines whether a destination has already been specified. If the destination has already been specified (YES in step S505), the processing proceeds to step S506. In step S506, the MFP 100 determines whether a document is placed on the scanner 110. If a document is placed on the scanner 110 (YES in step S506), the processing proceeds to step S507. In step S507, the MFP 100 determines whether the start button 706 has been pressed and the start of the function has been instructed. If the start button 706 has been pressed (YES in step S507), the processing proceeds to step S508. In step S508, the MFP 100 reads the document by using the scanner 110. In step S509, the MFP 100 converts the read data into an electronic file specified by the file format button 705. After the conversion into the electronic file, in step S510, the MFP 100 sends the electronic file to the specified destination by using the communication I/F controller 113. After sending the electronic file, in step S511, the MFP 100 records information about the SEND job in the storage device 109. In step S512, the MFP 100 also determines whether the SEND job has been executed successfully. If the SEND job results in a failure (NO in step S512), the processing proceeds to step S513. In step S513, the MFP 100 sends the information about the SEND job to the diagnostic server 200 by using the communication I/F controller 113, along with the device serial number, which can uniquely determine the MFP 100 itself. If the SEND job has been executed successfully (YES in step S512) or after the MFP 100 sends the information about the SEND job to the diagnostic server 200, the processing proceeds to step S514. If any one of the conditions in steps S505 to S507 is not satisfied, the processing returns to step S504.

Next, in step S514, the MFP 100 determines whether an information acquisition request has been received from the diagnostic server 200. If the information acquisition request has been received (YES in step S514), the processing proceeds to step S515. In step S515, the MFP 100 acquires information specified by the information acquisition request. In step S516, the MFP 100 sends the information to the diagnostic server 200 by using the communication I/F controller 113.

Steps S501 to S513 in the flowchart in FIG. 5 correspond to steps S401 to S405 in the sequence in FIG. 4, and steps S514 to S516 correspond to steps S416 and S417 in the sequence in FIG. 4.

### Process of Diagnostic Server 200

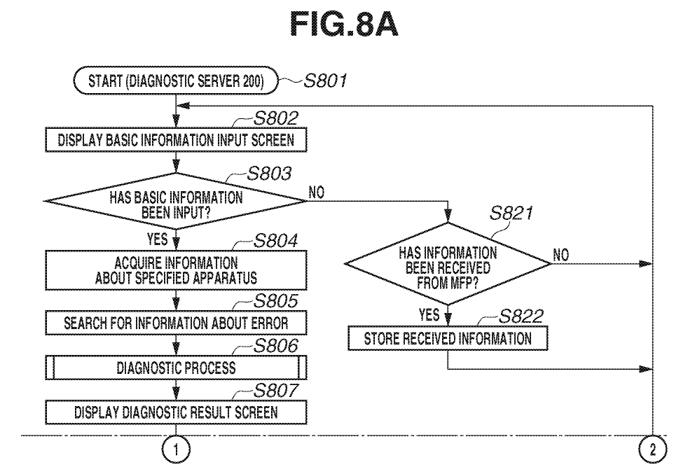

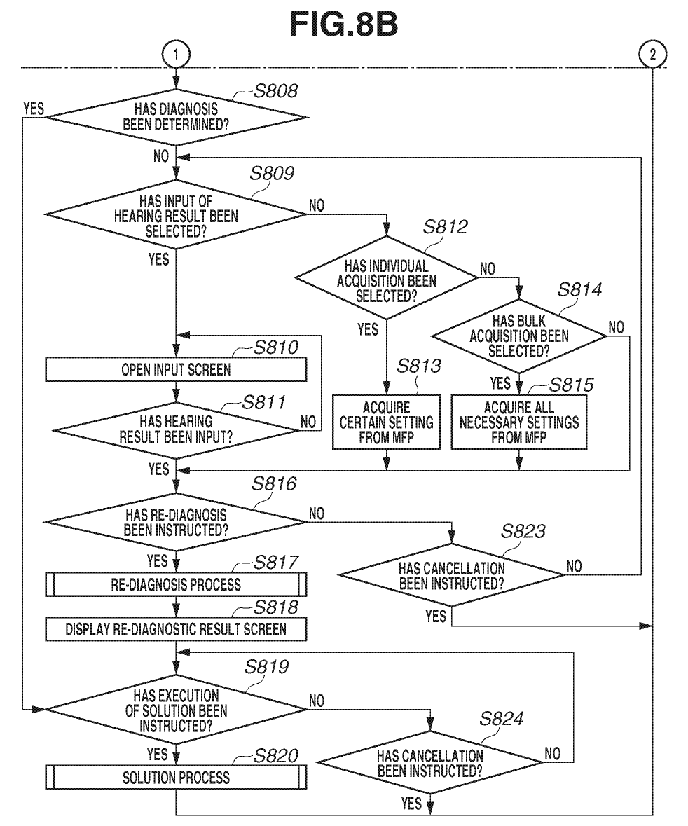

The process of the diagnostic server 200 will now be described in detail with reference to a flowchart illustrated in FIGS. 8A and 8B.

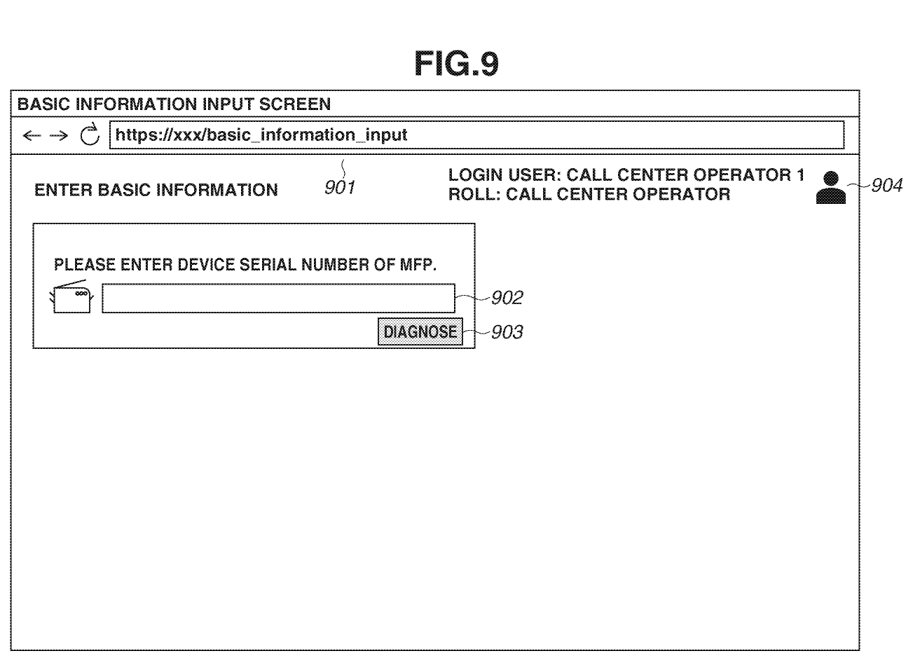

In step S801, the process is started. In step S802, the diagnostic server 200 provides the web browser of a basic information input screen 900 illustrated as an example in FIG. 9 to display the screen. After displaying the basic information input screen 900, the diagnostic server 200 determines, in step S803, whether basic information has been input to the screen and a diagnose button 903 has been pressed.

The present embodiment assumes that the device serial number for uniquely determining the MFP 100 that the user is inquiring about is input as the basic information. However, a subscriber number of the inquiring user, the model name of the MFP 100, the installation place, etc., are assumed to be the basic information. Two or more of the above items of information may be combined to uniquely determine the MFP 100. Alternatively, a screen for searching for the MFP 100 may be provided.

If the basic information has not been input (NO in step S803), the processing proceeds to step S821. In step S821, the diagnostic server 200 determines whether the information to be sent by the MFP 100 in step S513 has been received. If the diagnostic server 200 determines that the information has been received (YES in step S821), the processing proceeds to step S822. In step S822, the diagnostic server 200 associates the received information with the device serial number uniquely determining the MFP 100, and stores these items of associated information in the file storage 202. The processing then returns to step S802.If the diagnostic server 200 determines that the information has not been received (NO in step S821), the processing returns to step S802.

When the diagnose button 903 is pressed (YES in step S803), the processing proceeds to step S804. In step S804, the diagnostic server 200 acquires, from the file storage 202, information associated with the apparatus indicated by the device serial number, based on the device serial number entered in a device serial number input field 902. In step S805, the diagnostic server 200 extracts the information about the job in which an error has occurred, from the information acquired in step S804.

Next, in step S806, the diagnostic server 200 executes the diagnostic process, which will be described below, on the extracted information, and acquires a diagnostic result. The diagnostic result includes a list of candidate root causes for the error, the list having been currently obtained and having been narrowed down from the information about the error, and a list of information that needs to be additionally acquired to narrow down the candidates further.

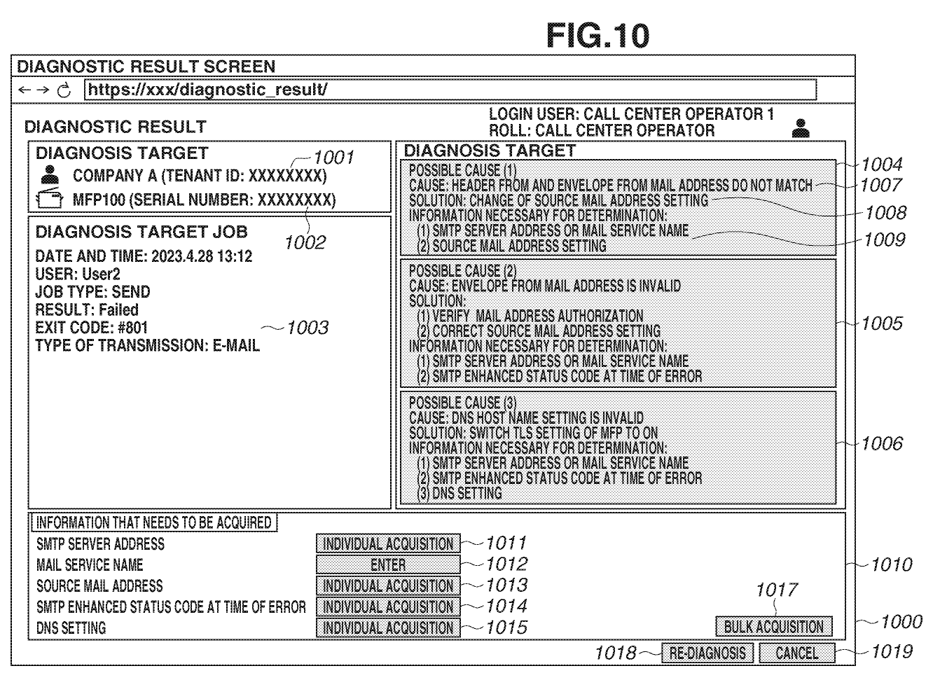

In step S807, the diagnostic server 200 provides the web browser with the list of candidate root causes, which has been obtained by the diagnostic process, and the list of information that needs to be additionally acquired, to display, for example, a diagnostic result screen 1000 illustrated as an example in FIG. 10.

The diagnostic result screen 1000 displays information 1002 about the diagnosis target MFP 100 indicated by the entered device serial number and information 1001 about the user who owns the MFP 100. In addition, the diagnostic result screen 1000 also displays information 1003 about the job in which the diagnosis target error has occurred, the information having been extracted in step S805, and the candidate root causes 1007 to be acquired in the diagnostic process in step S806. The diagnostic result screen 1000 also displays a solution 1008, and information 1009 that needs to be additionally acquired to determine the root cause, which are needed for a solution per candidate root cause. At the time of the diagnostic process in step S806, there may be a plurality of candidate root causes. In such a case, information such as 1004, 1005, and 1006 may be displayed as illustrated in FIG. 10.

In addition, a field 1010 displays an information set that needs to be additionally acquired to determine the root cause from the candidate root causes. Of all the information that needs to be additionally acquired, some data can be acquired by communicating with the MFP 100 by pressing an individual acquisition button 1011, 1013, 1014, or 1015, or a bulk acquisition button 1017. In contrast, of all the information that needs to be additionally acquired, some data is acquired by asking the user. For such data, the operator operates an input button 1012. By operating the input button 1012, an input screen is displayed so that the operator can enter information obtained by asking the user.

The data obtained by the diagnostic server 200 after the operator presses the individual acquisition buttons 1011, 1013, 1014, 1015, the bulk acquisition button 1017, the input button 1012, etc., is additionally stored as information about the job in which the error has occurred, the information having been acquired in step S805, and is used in a subsequent diagnostic process.

In step S808, the diagnostic server 200 checks whether the diagnosis has been determined. If there are a plurality of candidates and the diagnosis has not been determined as displayed on the diagnostic result screen 1000 illustrated in FIG. 10 (NO in step S808), the operator can operate the input button 1012. In step S809, the diagnostic server 200 determines whether the operator has pressed the input button 1012 and has given an instruction for input of a hearing result on the input screen (not illustrated). If the operator has operated the input button 1012 (YES in step S809), the processing proceeds to step S810. In step S810, the diagnostic server 200 additionally provides the input screen, and the processing proceeds to step S811. In step S811, the diagnostic server 200 determines whether the operator has entered information on the input screen. If the diagnostic server 200 determines that the operator has entered information on the input screen (YES in step S811), the processing proceeds to step S816. If not (NO in step S811), the process returns to step S810.

In the example in FIG. 10, the target of the input button 1012 is the mail service name. For example, the operator asks the user about information about a mail service name provided by a desired service provider used by a customer. Thus, a format is conceivable in which a list of mail service names that can be diagnosed by the diagnostic process to be described below are listed, and one of the mail service names is selected from the list. The format does not limit the present embodiment. As long as information can be used by the diagnostic process, any other method such as multiple-choice format or free-text entry may be used.

In step S812, the diagnostic server 200 determines whether at least one of the individual acquisition buttons 1011, 1013, 1014, and 1015 has been pressed, and whether an instruction for acquiring data such as a setting value has been received. If the diagnostic server 200 has received an instruction (YES in step S812), the processing proceeds to step S813. In step S813, the diagnostic server 200 sends the MFP 100 a request for acquiring data corresponding to the one or more buttons pressed. By receiving a reply from the MFP 100 in response to the request, the diagnostic server 200 acquires the necessary data.

In the example in FIG. 10, the individual acquisition button 1011 corresponds to the SMTP server address, the individual acquisition button 1013 corresponds to the source mail address, the individual acquisition button 1014 corresponds to the SMTP Enhanced Status Code at the time of the error, and the individual acquisition button 1015 corresponds to the DNS setting. The diagnostic server 200 sends the MFP 100 a request for a setting value corresponding to a pressed button.

In step S814, the diagnostic server 200 determines whether the operator has pressed the bulk acquisition button 1017 for an instruction for bulk acquisition of necessary data such as setting values. If the diagnostic server 200 has received the instruction (YES in step S814), the processing proceeds to step S815. In step S815, the diagnostic server 200 sends the MFP 100 one or more requests for acquiring all the data corresponding to the individual acquisition buttons 1011, 1013, 1014, and 1015. By receiving a reply from the MFP 100 in response to these requests, the diagnostic server 200 acquires necessary data.

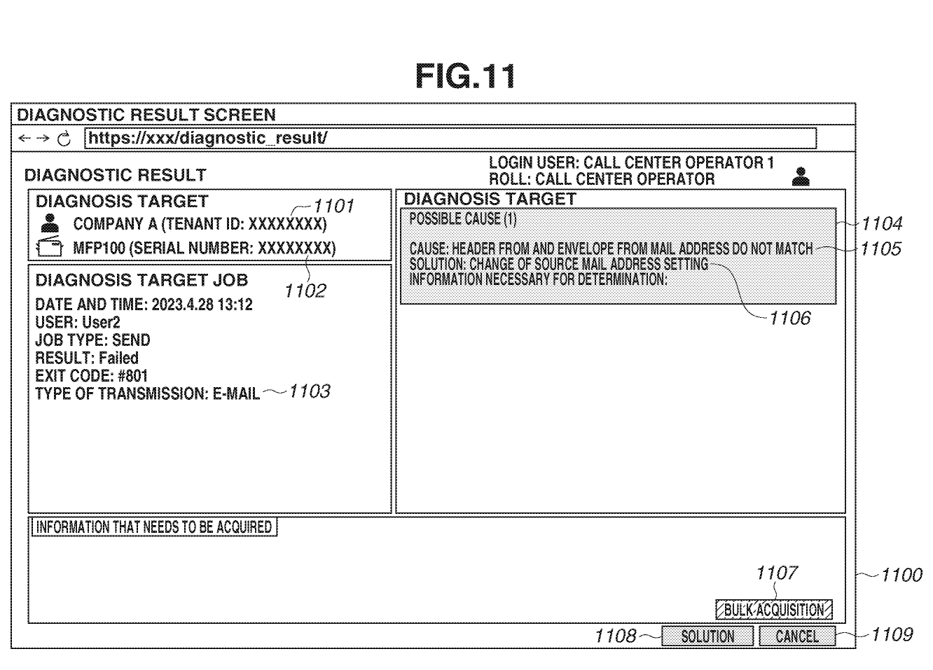

In step S816, the diagnostic server 200 determines whether an instruction for re-diagnosis has been entered by a re-diagnosis button 1108. If the diagnostic server 200 determines the instruction has been entered (YES in step S816), the processing proceeds to step S817. In step S817, the diagnostic server 200 executes a re-diagnostic process to be described below. Then, in step S818, the diagnostic server 200 provides a re-diagnostic result screen to be displayed on the web browser. On the re-diagnostic result screen, since the candidate root causes have been narrowed down to one root cause by the re-diagnosis, it is assumed that a diagnostic result screen 1100 illustrated as an example in FIG. 11 is displayed.

In step S819, after displaying the re-diagnostic result screen, the diagnostic server 200 determines whether an instruction for executing the solution has been entered by the re-diagnosis button 1108. If the diagnostic server 200 determines the instruction of the solution (YES in step S819), the processing proceeds to step S820. In step S820, the diagnostic server 200 executes a solution process, which will be described below, and the processing returns to step S802. If the diagnostic server 200 does not determine the instruction of the solution (NO in step S819), the processing proceeds to step S824. In step S824, the diagnostic server 200 determines whether the operation of a cancel button 1019 has been detected. If the diagnostic server 200 determines the cancel button 1019 has been nstructed (YES in step S824), the processing returns to step S802. If the diagnostic server 200 does not determine the cancel button 1019 has been instructed (NO in step S824), the process returns to step S819.

If the re-diagnosis has not been instructed (NO in step S816), the processing proceeds to step S823. In step S823, the diagnostic server 200 determines whether the cancel button 1019 has been operated to instruct cancelation. If the cancel button 1019 has been operated (YES in step S823), the processing returns to step S802. If the cancel button 1019 has not been operated (NO in step S823), the processing returns to step S809.

Depending on the error, the result of the diagnostic process in step S806 indicates one candidate root cause has been left, and the root cause can already be determined, as in the diagnostic result screen 1100 illustrated in FIG. 11 as an example. Thus, in step S808, the diagnostic server 200 determines whether the number of candidates is one and whether the diagnosis has been determined. If the diagnosis has been determined (YES in step S808), the processing proceeds to step S819.

Steps S803 to S807 in the flowchart in FIG. 8 correspond to steps S409 to S412 illustrated in the sequence in FIG. 4. Steps S816 to S818 in the flowchart in FIG. 8 correspond to steps S415 to S419 illustrated in the sequence in FIG. 4.

### Diagnostic Process and Re-diagnostic Process

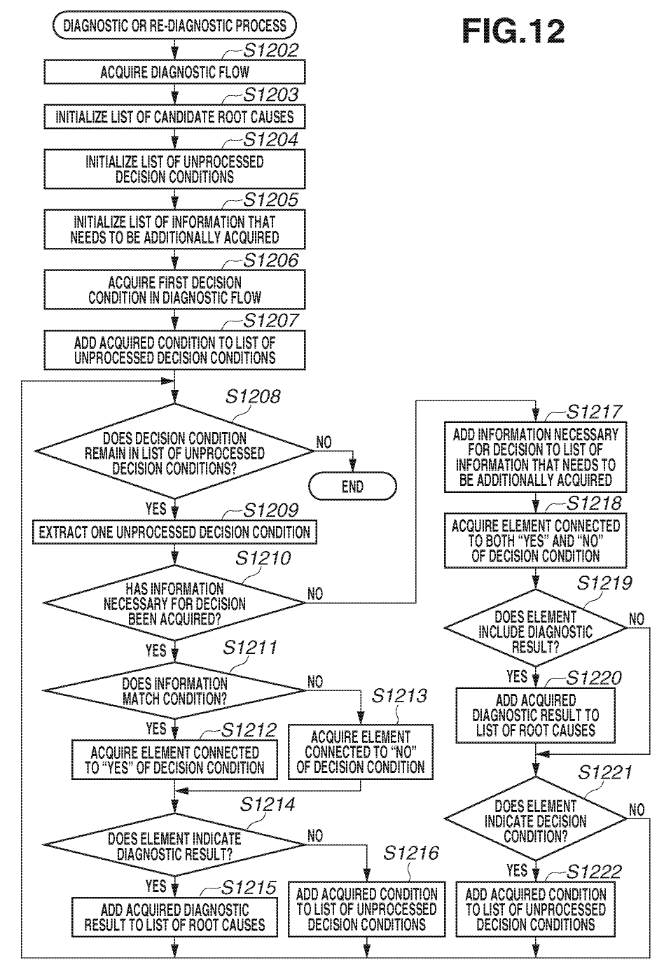

The diagnostic process and the re-diagnostic process executed by the diagnostic server 200 will be described with reference to a flowchart in FIG. 12. This flowchart is for specifically describing steps S806 and S817.

In the present embodiment, an example will be described in which the process logic of the diagnostic process and the processing logic of the re-diagnostic process have the same content. However, since more information can be used for the re-diagnosis process, the re-diagnostic process differs from the diagnostic process in that the diagnostic server 200 is more likely to acquire more different narrowly filtered results. In the re-diagnostic process, processing other than the diagnostic process related to the newly acquired information may be omitted.

When the diagnostic or re-diagnostic process is started, in step S1202, the diagnostic server 200 acquires a diagnostic flow. Based on information about the target apparatuses, the diagnostic server 200 may acquire one or more diagnostic flows and execute the diagnostic processes in parallel.

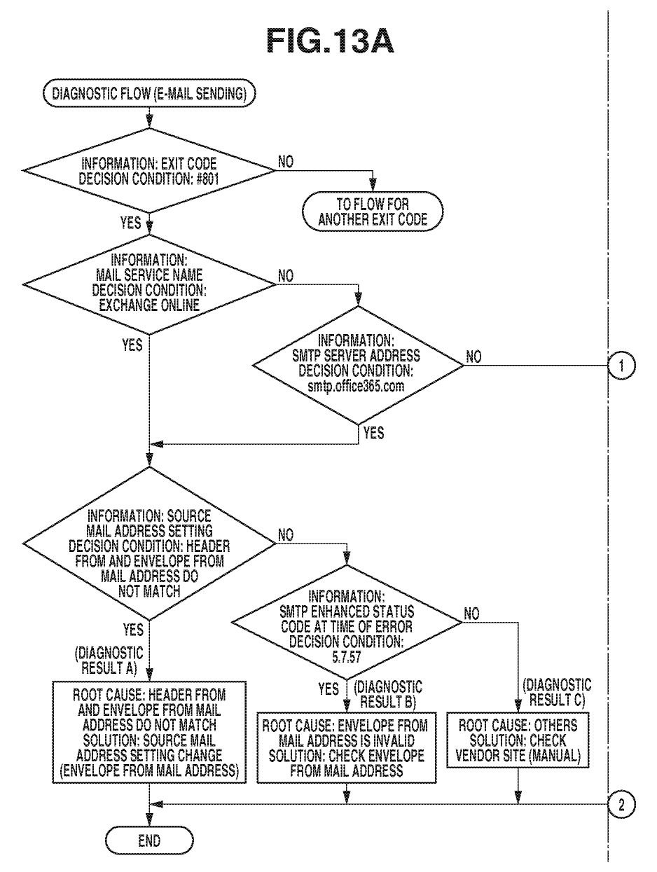

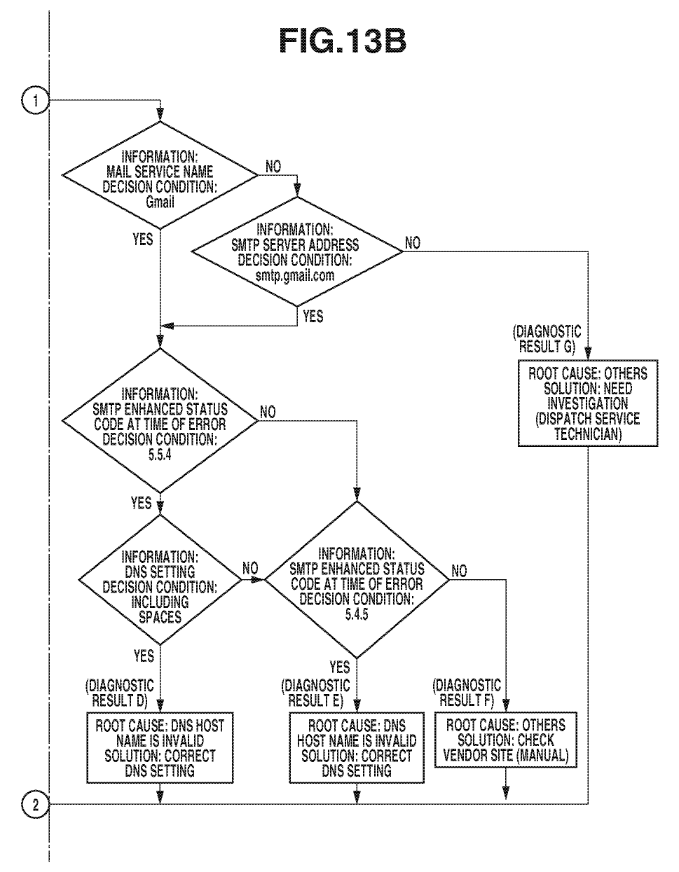

FIGS. 13A and 13B illustrate an example of an excerpt from a diagnostic flow. The diagnostic flow is present for each function in which an error has occurred. The diagnostic server 200 acquires a diagnostic flow matching the information about the error found in step S805. In FIGS. 13A and 13B, the diagnostic flow of the mail sending function will be described as an example.

The diagnostic flow illustrated in FIG. 13 includes a plurality of decision condition steps and a plurality of elements indicating diagnostic results (diagnostic results A to G). In each decision condition step, the information and condition used for the decision are determined, based on, for example, the operation information and setting information that have been acquired by the diagnostic server 200 from the target apparatus via the network 1000 and based on the information entered by the operator. The check process is executed by determining whether each condition is satisfied (Yes) or not (No). The decision contents are as indicated in FIG. 13, and thus detailed description thereof will be omitted. The diagnostic server 200 executes the flow based on the decisions, and finally acquires an element indicating any one of the diagnostic results. Each diagnostic result includes the root cause of the error and the solution to the root cause. Depending on the type of the diagnostic flow, there is a flow that outputs a plurality of candidate root causes of the error and solutions to these root causes.

Next, in step S1203, the diagnostic server 200 initializes the list of candidate root causes, as the area in which the diagnostic results are stored. In step S1204, the diagnostic server 200 also initializes the list of unprocessed decision conditions, as the area in which temporary information is stored when the diagnostic process is executed. Next, in step S1205, the diagnostic server 200 initializes the list of information serving as the area in which the information that needs to be additionally acquired is stored.

In step S1206, the diagnostic server 200 acquires a decision condition, which is the starting point of the diagnostic flow acquired in step S1202. In step S1207, the diagnostic server 200 adds the decision condition to the list of unprocessed decision conditions.

In step S1208, the diagnostic server 200 determines whether a decision condition remains in the list of unprocessed decision conditions. If a decision condition remains in the list of unprocessed decision conditions (YES in step S1208), the processing proceeds to step S1209. If a decision condition does not remain in the list of unprocessed decision conditions (NO in step S1208), the processing ends, and the diagnostic server 200 executes the next process illustrated in FIG. 8.

In step S1209, the diagnostic server 200 extracts one decision condition from the list of unprocessed decision conditions. Next, in step S1210, the diagnostic server 200 determines whether the information to be the decision target included in the acquired decision condition has already been acquired. If the information has already been included (YES in step S1210), the processing proceeds to step S1211. In step S1211, the diagnostic server 200 determines whether the information to be the decision target satisfies or matches the decision condition included in the acquired decision condition.

If the information satisfies or matches the decision condition (YES in step S1211), the processing proceeds to step S1212. In step S1212, the diagnostic server 200 acquires an element connected to “Yes” of the decision condition element. If the information does not satisfy or match the decision condition (NO in step S1211), the processing proceeds to step S1213. In step S1213, the diagnostic server 200 acquires an element connected to “NO” of the decision condition element.

In step S1214, the diagnostic server 200 determines whether the element acquired in step S1212 or S1213 is a diagnostic result. If the element is a diagnostic result (YES in step S1214), the processing proceeds to step S1215. In S1215, the diagnostic server 200 adds the acquired diagnostic result element in the list of root causes. If the element is not a diagnostic result (NO in step S1214), the processing proceeds to step S1216. In step S1216, the diagnostic server 200 adds the acquired element in the list of unprocessed decision conditions. After step S1215 or S1216, the processing returns to step S1208, and the diagnostic server 200 repeats the series of steps described above until no unprocessed decision condition remains in the list of unprocessed decision conditions.

In step S1210, if the diagnostic server 200 determines that the information necessary for the decision has not been acquired yet (NO in step S1210), the processing proceeds to step S1217. In step S1217, the diagnostic server 200 adds information to be the decision target included in the decision condition in the list of information that needs to be additionally acquired. Next, in step S1218, the diagnostic server 200 acquires an element connected to both “Yes” and “No” of the decision condition. In step S1219, the diagnostic server 200 determines whether a diagnostic result is included in the acquired element. If a diagnostic result is included in the acquired element (YES in step S1219), the processing proceeds to step S1220. In step S1220, the diagnostic server 200 adds the diagnostic result element in the list of root causes. If a diagnostic result is not included in the acquired element (NO in step S1219), or after step S1220 is executed, the processing proceeds to step S1221. In step S1221, the diagnostic server 200 determines whether a decision condition element is included in the element. If a decision condition element is included (YES in step S1221), the diagnostic server 200 adds the decision condition in the list of unprocessed decision conditions. If a decision condition element is not included (NO in step S1221), or after step S1222 is executed, the processing returns to step S1208.

Upon completion of the diagnostic process or re-diagnostic process, the diagnostic results in the list of candidate root causes and the information remaining in the list of information that needs to be additionally acquired are displayed on the diagnostic result screen in step S807, or are used for the display of the re-diagnostic result screen in step S818. Whether the number of diagnostic results in the list of candidate root causes is one is used in the diagnosis determination decision in step S808.

### Solution Process

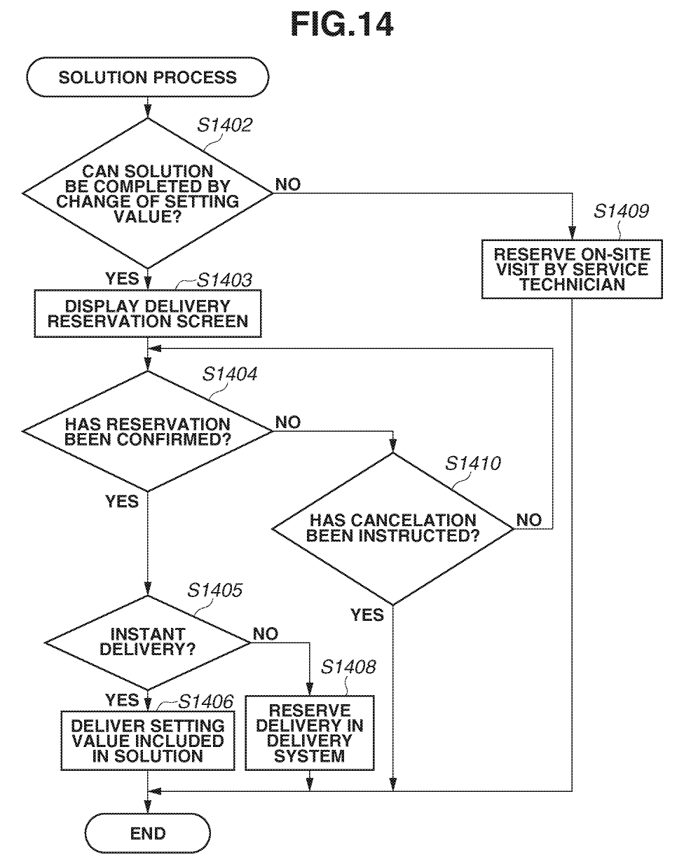

The solution process (details in step S820) executed by the diagnostic server 200 will be described with reference to a flowchart in FIG. 14. Since the solution process is executed when a diagnosis has been determined by the diagnostic process or after the re-diagnostic process, the number of candidate diagnostic results is only one.

When the solution process is started, the diagnostic server 200 determines, in step S1402, whether the solution included in the diagnostic result can be completed only by executing a setting value change, using a setting value delivered to the MFP 100. If the solution can be completed only by executing a setting value change (YES in step S1402), the processing proceeds to step S1403. If the solution needs work other than a delivery of a setting value, for example, a manual operation at the installation place of the MFP 100 (NO in step S1402), the processing proceeds to step S1409. In step S1409, an on-site visit by a service technician who executes MFP maintenance work is reserved, and the processing ends. The reservation is confirmed based on the schedule of the customer or the schedule of the service technician.

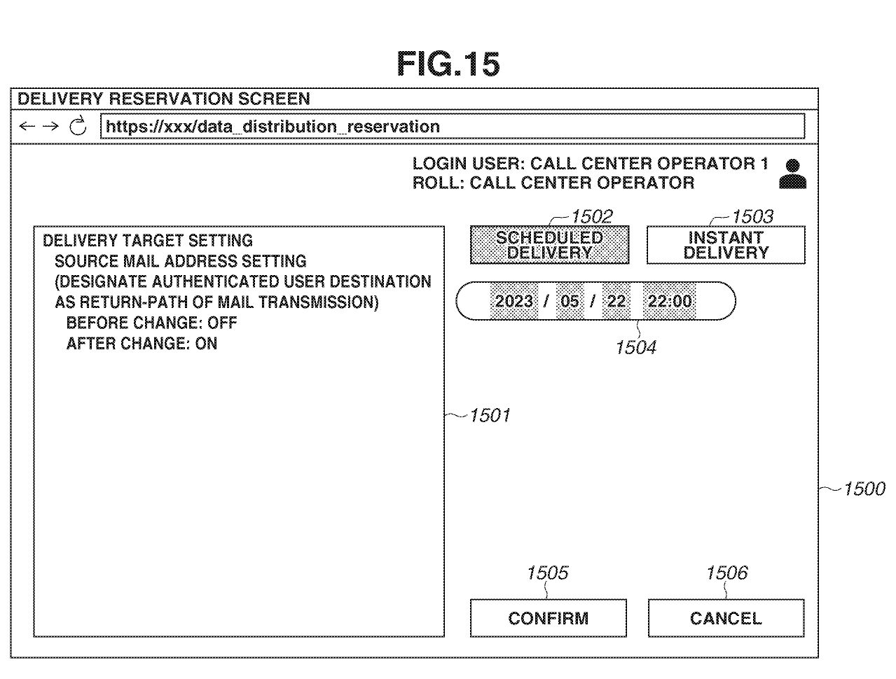

In step S1403, the diagnostic server 200 provides the web browser or the like with a delivery reservation screen 1500 illustrated in FIG. 15 as an example. The delivery reservation screen 1500 includes a delivery setting value display field 1501 indicating information about a setting value delivered to the MFP 100, which is the solution included in the determined diagnostic result, a scheduled delivery button 1502 for specifying the delivery time, an instant delivery button 1503 for executing delivery instantly, a time input field 1504 for specifying the delivery time, a confirm button 1505 for confirming the input, and a cancel button 1506 for canceling the delivery reservation.

In step S1404, the diagnostic server 200 determines whether the confirm button 1505 has been pressed. If the confirm button 1505 has been pressed (YES in step S1404), the processing proceeds to step S1405. If the confirm button 1505 has not been pressed (NO in step S1404), the processing proceeds to step S1410.

As a result, in accordance with the user operation, the setting value indicated in the delivery setting value display field 1501 in FIG. 15 is delivered to the MFP 100 instantly or at the reserved time. The scheduled delivery button 1502 and the instant delivery button 1503 constitute a toggle switch, and thus only one of these buttons can be enabled.

In step S1405, the diagnostic server 200 determines whether the instant delivery button 1503 is enabled. If the instant delivery button 1503 is enabled (YES in step S1405), the processing proceeds to step S1406. In step S1406, in response to the pressing of the confirm button 1505, the diagnostic server 200 instantly delivers the setting value included as the necessary solution to the MFP 100 via the network. This delivery is executed instantly via the delivery system.

If the instant delivery button 1503 is disabled, that is, if the scheduled delivery button 1502 is enabled (NO in step S1405), the processing proceeds to step S1408. In step S1408, the diagnostic server 200 sets, in the delivery system, a reservation for delivering the setting value at the time entered in the time input field 1504.

Any of various protocols referred to as WebSocket and MQTT can be used as the protocol for the delivery of the setting value from the diagnostic server 200 to the MFP 100. In addition, the delivery system is a system that manages reservation of the delivery of a setting value and delivers the data to the MFP 100 at the scheduled time.

In step S1410, the diagnostic server 200 determines whether the cancel button 1506 has been operated. If there is an instruction to stop by the operation of the cancel button 1506 (YES in step S1410), the processing ends. If there is not the instruction (NO in step S1410), the processing returns to step S1404.

### Other Embodiments

The present disclosure includes an apparatus, a system, or a method constituted by suitably combining the above embodiments.

The present disclosure is not limited to the above-described embodiments. Various modifications and variations are possible without departing from the spirit and scope of the present disclosure. Thus, the following claims are attached to make the scope of the present disclosure public.

The present disclosure provides a mechanism for efficiently acquiring additional information when a diagnostic system needs re-diagnosis.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A diagnostic system comprising:
at least one memory storing instructions; and
at least one processor that, when executing the instructions, causes the diagnostic system to
execute a diagnostic process for determining, by using operation information about an image processing apparatus and a setting value of the image processing apparatus, a cause of a trouble that has occurred in the image processing apparatus and a solution to the trouble,
provide a screen configured to display a diagnostic result of the diagnostic process and information necessary for re-diagnosis obtained from the image processing apparatus, and
receive at least one of an instruction for acquiring the information necessary for re-diagnosis from the image processing apparatus and an instruction for entering the information necessary for re-diagnosis by an operator via the screen,
wherein the diagnostic process is executed again, based on the information necessary for re-diagnosis.

2. The diagnostic system according to claim 1,
wherein an instruction for executing a solution included in the diagnostic result is received via the screen, and
wherein, in a case where a solution included in the diagnostic result is a delivery of a setting value to the image processing apparatus, a delivery reservation screen for setting the delivery of the setting value is provided.

3. The diagnostic system according to claim 2, wherein a delivery of the setting value is executed to the image processing apparatus in accordance with a setting on the delivery reservation screen by using a delivery system.

4. The diagnostic system according to claim 1, the at least one processor further causes the diagnostic system to request the image processing apparatus for operation information used in the diagnostic process via a network.

5. A method used in a diagnostic system, the method comprising:
executing a diagnostic process for determining, by using operation information about an image processing apparatus and a setting value of the image processing apparatus, a cause of a trouble that has occurred in the image processing apparatus and a solution to the trouble;
providing a screen configured to display a diagnostic result of the diagnostic process and information necessary for re-diagnosis obtained from the image processing apparatus; and
receiving at least one of an instruction for acquiring the information necessary for re-diagnosis from the image processing apparatus and an instruction for entering the information necessary for re-diagnosis by an operator via the screen,
wherein the diagnostic process is executed again, based on the information necessary for re-diagnosis.
